(19) United States
(12) Patent Application Publication
(10) Pub. No.: US 2018/0005540 A1
(43) Pub. Date: Jan. 4, 2018

(54) DYNAMIC AND ADAPTIVE LEARNING SYSTEM GENERATOR

(71) Applicant: International Business Machines Corporation, Armonk, NY (US)

(72) Inventors: Malolan Chetlur, Bangalore (IN); Bikram Sengupta, Bangalore (IN); Renuka R. Sindhgatta, Bangalore (IN); Komminist S. Weldemariam, Nairobi (KE)

(21) Appl. No.: 15/198,014

(22) Filed: Jun. 30, 2016

(51) Int. Cl. G09B 7/00; G06F 3/0482; G06F 3/0484; G09B 5/02; G06Q 40/02; G06Q 50/20

(52) U.S. Cl. CPC G09B 7/00; G09B 5/02; G06Q 40/02; G06F 3/0482; G06F 3/04847; G06Q 50/20

(57) ABSTRACT

A method is disclosed including receiving, by a user interface, an activation of at least one activatable element indicating a selected concept, and in response to receiving the activation indicating the selected concept, identifying at least one prerequisite concept to the selected concept, determining a readiness score of a group of students for learning the at least one identified prerequisite concept, determining a readiness score of the group of students for learning the selected concept based at least in part on the determined readiness score for learning the at least one identified prerequisite concept, determining a total teaching cost for teaching the group of students the selected concept, generating a learning system for teaching the selected concept based at least in part on the determined total teaching cost, and presenting the recommended learning system to the user via the user interface.

### FIELD

The present application relates generally to dynamically and adaptively generating learning systems and in particular to the automatic generation of learning systems for teaching concepts to students.

### BACKGROUND

Generating a learning system often requires various forms of information such as the target school, target teacher, a target date, a duration of available time, a subject matter or concept to be taught by the learning system (including learning objectives), and the method and resources that may be used by the learning system (e.g., contents, assessments/quizzes). The learning system may often need to be generated based on required curriculums prescribed by the target school, district and/or state education requirements. Generating a learning system may also require the preparation or selection of learning resources for use with a lesson. Learning resources are often available from various sources including the internet for resources, school databases of resources, or any other database that may include resources that may be used with learning systems.

### BRIEF SUMMARY

The methods, systems, and computer program products described herein provide a way to automatically and dynamically generate learning systems.

In an aspect of the present disclosure, a method is disclosed including presenting a user interface on a display of a computing device. The user interface may be configured to present learning systems to a user. The user interface may include at least one element that is activatable by a user to select a concept to be used in generating a learning system for teaching the concept to one or more students. The method may further include receiving from the user via the user interface an activation of the at least one element. The activation may indicate a selected concept. In response to receiving the activation indicating the selected concept, the method further includes identifying at least one prerequisite concept to the selected concept and determining a readiness score of a group of students for learning the at least one identified prerequisite concept. The readiness score may be based at least on a proficiency of the group of students in the at least one identified prerequisite concept. The method further includes determining a readiness score of the group of students for learning the selected concept based at least in part on the determined readiness score of the group of the students for learning the at least one identified prerequisite concept, determining a total teaching cost for teaching the group of students the selected concept, the total teaching cost based at least in part on: a teaching cost associated with teaching the selected concept to the group of students, a teaching cost associated with teaching the at least one prerequisite concept to the group of students, and the determined readiness scores of the group of students for learning the selected concept and the at least one prerequisite concept. The method further includes generating a learning system for teaching the selected concept based at least in part on the determined total teaching cost, and presenting the learning system to the user via the user interface.

In aspects of the present disclosure apparatus, systems, and computer program products in accordance with the above aspect may also be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a system diagram of a system for automatically and dynamically generating optimal learning systems in accordance with an aspect of the present disclosure.

FIG. 2 is an illustration of example learning systems in accordance with an aspect of the present disclosure.

FIG. 3 is an illustration of an example user interface for automatically and dynamically generating optimal learning systems in accordance with an aspect of the present disclosure.

FIG. 4 is an illustration of an example user interface for automatically and dynamically generating optimal learning systems in accordance with an aspect of the present disclosure.

FIG. 5 is a system architecture that may be used for automatically and dynamically generating optimal learning systems in accordance with an aspect of the present disclosure.

FIG. 6 is an example of a concept dependency graph in accordance with an aspect of the present disclosure.

FIG. 7 is a flow chart illustrating an example method of automatically and dynamically generating optimal learning systems in accordance with an aspect of the present disclosure.

FIG. 8 illustrates a schematic of an example computer or processing system that may implement any component of the system for automatically and dynamically generating optimal learning systems in accordance with an aspect of the present disclosure.

### DETAILED DESCRIPTION

The methods, systems, and computer program products described herein provide ways to automatically and dynamically generate a learning system based on student readiness for learning a particular concept.

One consideration may be taken into account when generating a learning system is the performance of students in the class on pre-requisite concepts that may be required or useful for understanding the concept of the learning system. For example, it may be important for a student to understand a mathematical concept before learning physics concepts that employ the mathematical concept. When generating a learning system including an optimal set of learning resources for teaching a concept C, a readiness of the students in the class to learn concept C may be taken into account. This readiness may be based on a level of proficiency of the students in concepts that are pre-requisite to concept C, for example, concepts C′. Knowledge gaps about the pre-requisite concept C′ that the students may have both on an individual basis and a group basis may be identified and taken into account. An optimal set of learning resources (LR) for the concept C that is tailored to the needs of the students as a group and to the needs of each student individually may also need to be identified. A classroom readiness score R may also be calculated based on an identified level of proficiency of the students in concept C′. Based on the classroom readiness score R, recommended interventions to be used by the learning system may be identified. For example, if the classroom readiness score R is below a predetermined threshold, the generated learning system may include learning resources and/or a lectures on concept C′ to refresh the students in the pre-requisite concepts found in C′ before starting a lecture and providing learning resource on the concept C.

In some aspects, a learning system may include learning activities, learning materials, groupings of students, and a sequence of learning activities to be performed by the groupings of students within a defined period of time to arrive at certain learning proficiencies.

In some aspects, a teaching cost T may include a cost in terms of an amount of time and/or teaching activities that may be required by a tutor/teacher/facilitator using the learning system to teach a group of students to attain a specific learning proficiency. The teaching cost may or may not include learning materials and learning activities.

In some aspects, a teaching or accrual debt D may include a debt or loss of value that may be incurred if a recommended set of activities from the learning system (e.g., refreshing pre-requisite concepts found in concept C′) are not implemented by the teacher using the learning system and as a result the students fail to attain a specific level of learning proficiency in concept C. In some aspects, accrual debt D may be equivalent to the teaching cost T of any recommended prerequisite activities or concepts of the learning system that a teacher decides not to implement prior to teaching a lesson on concept C.

In some aspects, a readiness Score R may include a proficiency score of a group of students in terms of the prerequisite concepts (e.g., concept C′) and necessary skills required to attain new proficiencies in a future concept (e.g., concept C) to be taught. In some embodiments, readiness score R may include proficiency scores for individual students. In some aspects, readiness scores may be numerical values, for example, zero to one-hundred, zero to one-thousand, or other similar values. In some aspects, readiness scores may be a percentage of proficiency, for example, 50% proficient, 75% proficient, etc. In some aspects, readiness scores may be a decimal value, for example, 0.0 to 1.0, 0.00 to 1.00, etc. For example, a readiness score of 50% may also be provided as 0.50, a readiness score of 75% may also be provided as 0.75, etc.

In some aspects, an optimally generated learning system may minimize teaching cost T while taking into account the readiness scores R of the student groups to limit the accrual of debt D.

In an example, a teacher may wish to introduce the concept of multiplication to students in a class. Before introducing the concept of multiplication, however, two other pre-requisite concepts may need to be well understood by the students. During generation of the learning system, the readiness scores of the students for both of the pre-requisite concepts may be evaluated. The learning system may include an identification of student clusters based on the readiness score. For example, students having readiness scores above a pre-determined threshold readiness score may be added to a first student cluster. Students having readiness scores below the pre-determined threshold readiness score may be added to a second student cluster. Students may be broken up into any number of student clusters based on their readiness scores in any other manner. For example, a first student cluster may include students having readiness scores between 0% and 25%, a second student cluster may include readiness scores between 26% and 50%, a third student cluster may include readiness scores between 51% and 75%, and a fourth student cluster may include readiness scores between 76% and 100%.

In some aspects, a first learning system may be generated for a student cluster having a higher readiness score that includes a short practice assignment for both pre-requisites before proceeding to the lecture on the main concept. For example, for a student cluster having readiness scores greater than 75%, the generated learning system may include a learning system including a five minute practice assignment for both pre-requisites before proceeding to the lesson on multiplication. In some aspects, a second learning system may be generated for a student cluster having a lower readiness score that includes additional practice assignments for the pre-requisites to increase the readiness score of the student cluster before proceeding to the lecture on the main concept. For example, for a student cluster having readiness cores less than 50%, the generated learning system may include a ten minute group activity for skip counting, a five minute activity on determining odd and even groups, and additional teaching tasks on application problem explanation before proceeding to the lesson on multiplication.

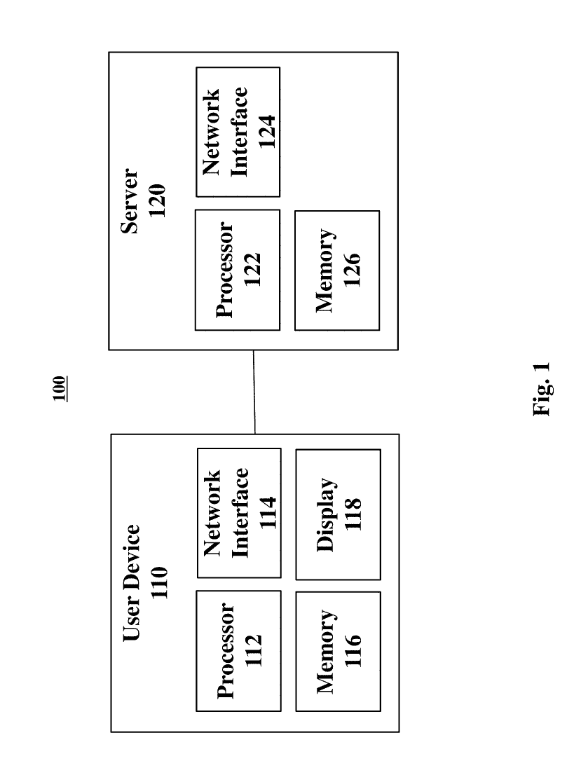

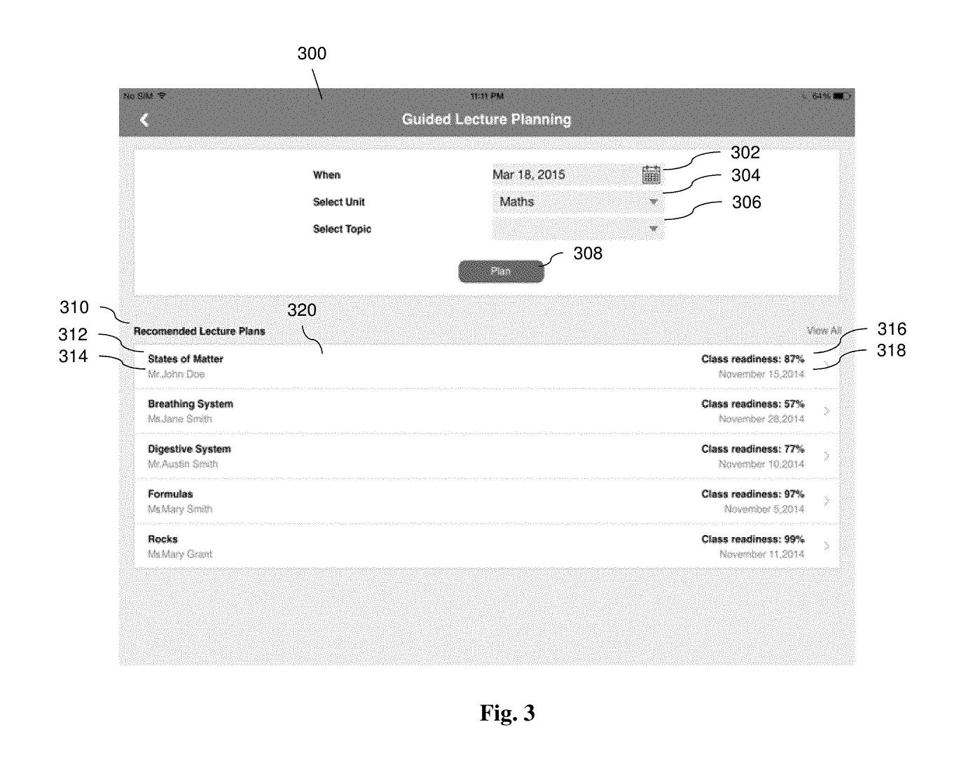

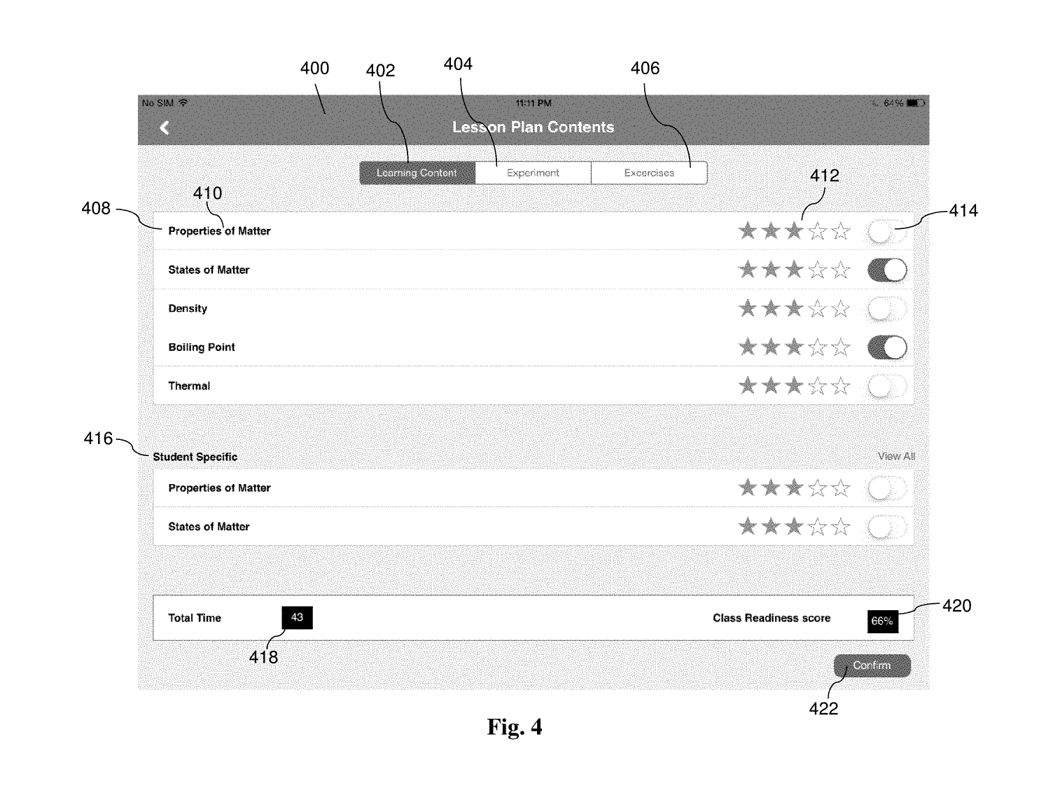

With reference to FIG. 1, a system 100 is illustrated. System 100 may include, for example, a user device 110 including at least one processor 112, network interface 114, memory 116, and display 118. User device 110 may be, for example, a personal computer, laptop, mobile phone, smart phone, smart watch, PDS, tablet, or other similar devices. User device 110 may be configured to display on display 118 a user interface to a user, for example, the user interfaces 300 and 400 illustrated in FIGS. 3 and 4.

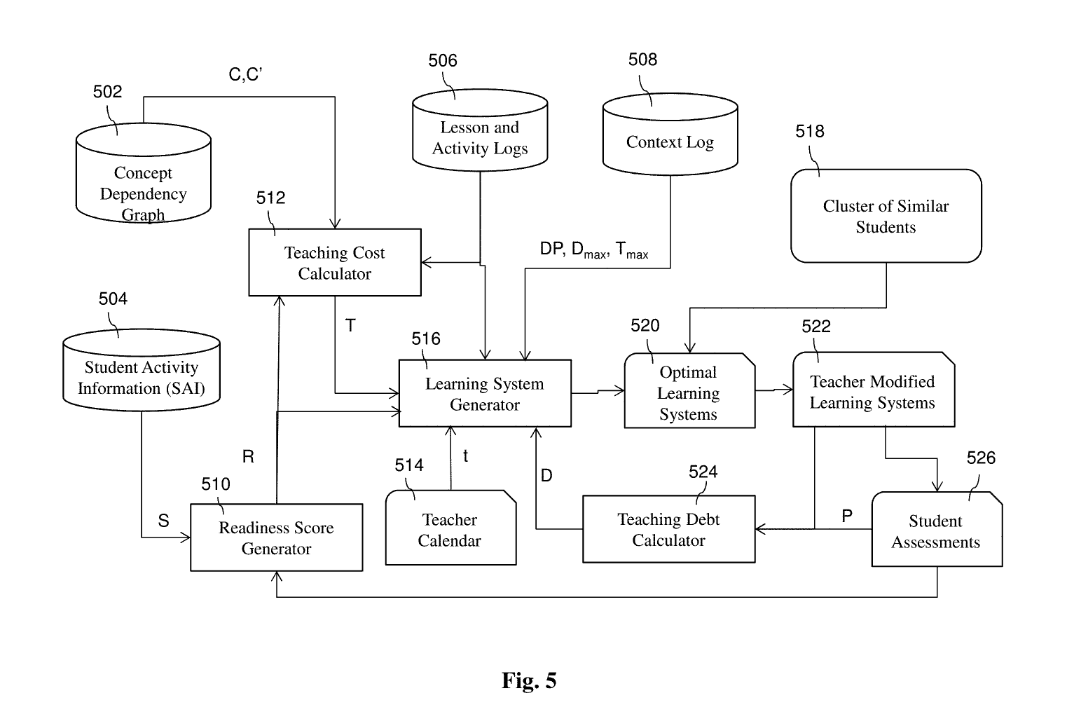

System 100 may also include a server 120 including at least one processor 122, network interface 124, and memory 126. In some aspects, server 120 may store databases or other information related to learning systems in memory 126 for use by user device 110. For example, server 120 may store in memory 126 concept dependency graphs 502 (FIG. 5) for concepts C, Student activity information 504 (FIG. 5), lesson and activity logs 506 (FIG. 5), Context Logs 508 (FIG. 5), teacher calendars 514 (FIG. 5), student assessments 526 (FIG. 5), or other similar information or data that may be used in generating a learning system. User device 110 may communicate with server via network interfaces 114 and 124 to transmit and receive the information and data related to learning systems stored by server. Network interfaces 114 and 124 may communicate via wired, wireless, or any other communications system. In some aspects, the information and data related to generating a learning system may additionally or alternatively be stored or accessible directly in memory 116 of user device 110 without the need for a server 120.

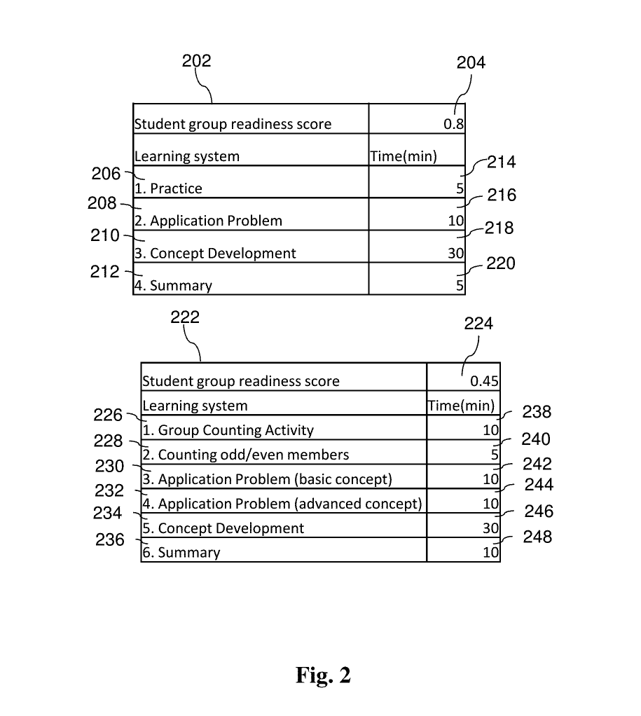

With reference to FIG. 2, an example learning system 202 for a student cluster including a readiness score of 0.8, e.g., a high readiness score, and an example learning system 222 for a student cluster having a readiness score of 0.45, e.g., a low or moderate readiness score, are illustrated.

Learning system 202 includes group readiness score 204, a first component 206, a second component 208, a third component 210, and a fourth component 212. As illustrated, first component 206 may be a practice component, for example, practice questions relating to one or both of the pre-requisite concepts C′. First component 206 may be associated with a corresponding duration 214, for example, five minutes. Second component 208 may be an application problem relating to concept C. Second component 206 may be associated with a corresponding duration 216, e.g., ten minutes. Third component 210 may be concept development relating to concept C. Third component 210 may be associated with a corresponding duration 218, e.g., thirty minutes. Fourth component 212 may be a summary of concept C. Fourth component 212 may be associated with a corresponding duration 220, e.g., five minutes.

Example learning system 222 includes group readiness score 224, a first component 226, a second component 228, a third component 230, a fourth component 232, a fifth component 234, and a sixth component 236. As illustrated, first component 226 may be a group counting activity related to one or both of the pre-requisite concepts C′. First component 226 may be associated with a corresponding duration 238, for example, ten minutes. Second component 228 may be a counting odd/even members activity related to one or both of the pre-requisite concepts C′. Second component 228 may be associated with a corresponding duration 240, e.g., five minutes. Third component 230 may be an application problem for a basic concept relating to concept C. Third component 230 may be associated with a corresponding duration 242, e.g., ten minutes. Fourth component 232 may be an application problem for an advanced concept relating to concept C. Fourth component 232 may be associated with a corresponding duration 244, e.g., ten minutes. Fifth component 234 may be concept development relating to concept C. Fifth component 234 may be associated with a corresponding duration 246, e.g., thirty minutes. Sixth component 236 may be a summary of concept C. Sixth component 236 may be associated with a corresponding duration 248, e.g., ten minutes.

As can be seen from example learning systems 202 and 222, the students in the student cluster having a group readiness score of 0.45 may require additional effort or teaching cost T on the part of the teacher in terms of both lesson time and in the corresponding amount of preparation for the lesson to achieve the proficiency level in concept C that is desired or required.

System 100 may recommend and rank the learning systems based on the proficiency level that all of the students need to attain. In some aspects, a user of system 100 may decide to utilize only a portion of a generated learning system. For example, if the user does not have a sufficient amount of time available, the user may remove or reduce certain activities or lectures that are included in the learning system. In some aspects, the removed activities or lectures may be pre-requisite activities that were intended to increase a proficiency one or more of the students to the desired proficiency level. If such activities or lectures are removed by the teacher, a teaching debt may be incurred and included either in the learning system or taken into account by system 100 for future lessons. The incurred teaching debt may be, for example, equivalent to the teaching cost T of the activities or lectures that would have been required to raise the readiness score of the student cluster to the required readiness score level for the concept to be taught by the learning system.

With reference now to FIGS. 3 and 4, example user interfaces 300 and 400 for selecting and generating learning systems are illustrated. User interface 300 may include an element 302 that is activatable to allow a user to select a target date for using a learning system. When activated, for example, element 302 may present a user with a calendar interface including day, month, year, times, or other similar planning criteria that may be activated or selected by the user to select a desired time and/or input the user's available time to teach the learning system. Additionally or alternatively, the user may input the desired date, time, etc. into element 302 via a user input device such as, for example, a keyboard.

User interface 300 also may include an element 304 that is activatable to allow a user to select a unit type. The unit type may be a generic classification of a group of concepts, for example, maths, science, history, etc. In some aspects, element 304 when activated by the user may present a drop-down menu of available unit types to the user and the user may activate or select a unit type from the drop-down menu. In some aspects, other similar selection features may be presented in response to an activation of element 304 by the user, for example, a radial selection dial may be presented, a separate window may pop up for receiving the user activation or selection, or other similar selection features.

User interface 300 may include an element 306 that is activatable to allow the user to select a concept. In some aspects, element 306, when activated by the user, may present a drop-down menu of available concepts to the user and the user may activate or select a concept from the drop-down menu. In some aspects, the available concepts may be based on the selected unit type. For example, if the user selects maths as the unit type using element 304, concepts related to maths may be available for selection by activating element 306. For example, activating element 306 may present the user with a drop-down menu of concepts including multiplication, addition, or other math related concepts. In some aspects, other similar selection features may be presented in response to an activation of element 306 by the user, for example, a radial selection dial may be presented, a separate window may pop up for receiving the user activation or selection, or other similar selection features.

User interface 300 may include an element 308 that is activatable by the user to generate learning systems for the selected date/time, availability, unit, and concept.

When element 308 is activated, user interface 300 may present a list of generated learning systems 310 to the user. Each learning system 310 may include a title 312, author/presenter 314, class readiness level 316, and date created 318. For example, a learning system 320 may include the title 312 of “states of matter”, author/presenter 314 of “Mr. John Doe”, a class readiness level 316 of 87%, and a date created 318 of “Nov. 15, 2014”. The user may activate any of learning systems 310 to see more detail as illustrated, for example, in FIG. 4.

With reference now to FIG. 4, user interface 400 may include a learning content element 402, an experiment element 404, and an exercise element 406. Learning content element 402 may be activatable by a user to cause presentation of a view including available lessons for inclusion in a learning system. For example, when user interface 400 receives a signal indicating an activation of learning content element 402 by a user, one or more lessons 408 may be displayed or presented by user interface 400. The one or more lessons 408 may be presented in the same window as learning content element 402, or in some aspects may be displayed in a separate window, e.g., a popup window. Each lesson 408 may include a title 410, for example, “Properties of Matter”, a rating 412, for example three of five stars, and an activatable element 414 that is activatable by the user to select the lesson 408 for inclusion in the learning system. Rating 412 may include any rating metric, for example, a star based rating as illustrated in FIG. 4, a metric rating, e.g., 5/10, or other similar metrics that may be used to rate an item of content. Activatable element 414 may, for example, be a button, slider, or any other selectable or activatable element that allows a user to indicate that a lesson 408 should be included in a learning system.

In some aspects, the view may also include student specific lessons 416. Student specific lessons 416 are lessons 408 that are tailored to a specific student or group of students generated based on the knowledge, skill, and preference/style models of the specific student or group of students, respectively.

In some aspects, a total time 418 for the selected lessons 408 and 416 may also be presented. Total time 418 may, for example, be equivalent to a teaching cost T of teaching the selected lessons 408 and 416. For example, if the activatable elements 414 for each of the “States of Matter” and “Boiling Point” lessons 408 are activated by the user, the total combined time for teaching both of the lessons may be presented, e.g., forty-three minutes.

In some aspects, class readiness score 420 for the selected lessons 408 and 416 may also be presented. For example, if the activatable elements 414 for each of the “States of Matter” and “Boiling Point” lessons 408 are activated by the user, the class readiness score 420 of 66% may be presented. In some aspects, the class readiness score 420 may be an average class readiness score for the selected lessons 408 and 416.

A confirm element 422 may be activated by the user once the user has selected the desired lessons to confirm the user's selection.

With further reference to FIG. 4, experiment element 404 may be activatable by a user to cause presentation of a view including available experiments for inclusion in a learning system. Experiments may be included or presented in response to the user activation of experiment element 404 in a similar manner to lessons 408 and 416 as described above.

With further reference to FIG. 4, exercise element 406 may be activatable by a user to cause presentation of a view including available exercises for inclusion in a learning system. Exercises may be included or presented in response to the user activation of exercise element 406 in a similar manner to lessons 408 and 416 as described above.

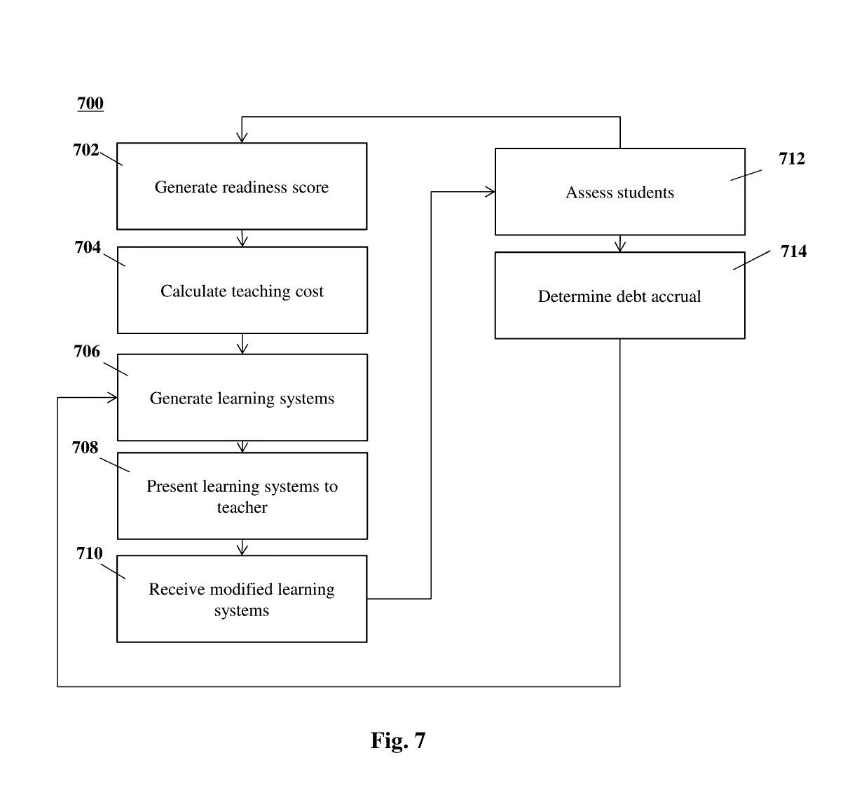

With reference now to FIGS. 5 and 7, a system architecture 500 and a method 700 for implementing automatic dynamic generation of learning systems are disclosed.

System architecture 500 includes concept dependency graphs 502, student activity information 504, lesson and activity logs 506, context log 508, readiness score generator 510, teaching cost calculator 512, teacher calendar 514, learning system generator 516, cluster of similar students 518, optimal learning systems 520, teacher modified learning systems 522, teaching debt calculator 524, and student assessments 526.

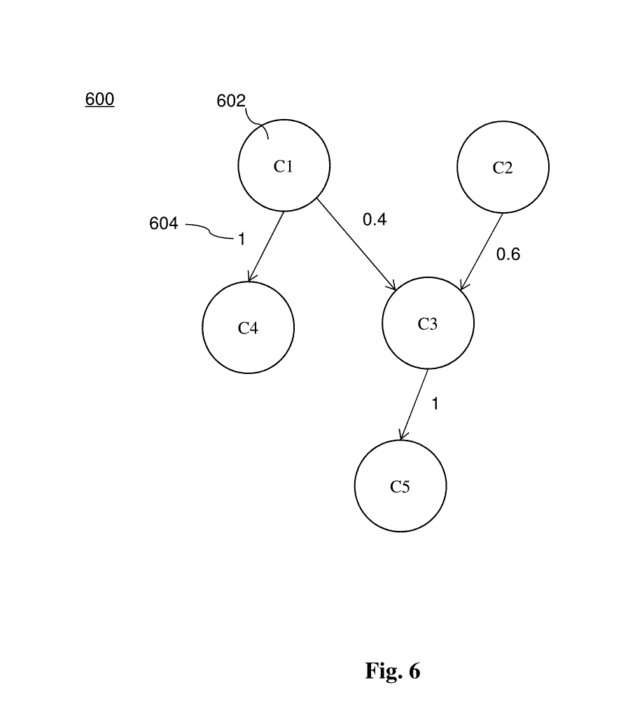

Concept dependency graph 502 includes data related to concepts C and C′. For example, concept dependency graphs 502 include concepts C, the prerequisite concepts C′ for concepts C and a relative weight of each prerequisite concept C′. Concept dependency graphs 502 may be stored in memory on user device 110, in memory on server 120, or in any other location. With reference to FIG. 6, an example 600 of a concept dependency graph 502 is illustrated. Example concept dependency graph 600 includes concepts 602, for example, concepts C1-C5. Example concept dependency graph 600 illustrates the dependencies of each concept C to any prerequisite concepts C′. For example, concept C3 is a prerequisite of concept C5, concepts C1 and C2 are prerequisites of concept C3, and concept C1 is a prerequisite of concept C4. In addition, a relative weight 604 of each prerequisite concept is also illustrated. For example, the relative weight 604 of concept C3 as a prerequisite for concept C5 is 1, e.g., 100%, since concept C3 is the only direct prerequisite of concept C5. As another example, the relative weight 604 of concept C1 as a prerequisite for concept C3 is 0.4, e.g., 40%, while the relative weight of concept C2 as a prerequisite for concept C3 is 0.6, e.g., 60%. In some aspects, the combined relative weights 604 of the prerequisite concepts may together equal 1, e.g., 100%.

Referring again to FIG. 5, student activity information (SAI) 506 includes data related to student groups S. For example, student activity information 506 may include an amount of time that the individual students have spent learning prerequisite concepts C′ including lectures and lesson activities. Student activity information 506 may be stored in memory on user device 110, in memory on server 120, or in any other location. SAI 506 stores various fine-grained data about student interactions with learning content, feedback, sentiment and sensor/device level information. In some aspects, SAI 506 may also store a context of the fine-grained data.

Lesson and activity logs 504 include data related to lessons and activities. Lesson and activity logs 504 may be stored in memory on user device 110, in memory on server 120, or in any other location. In some aspects, lesson and activity logs 504 may be included in SAI 506.

Context log 508 includes data related to the learning context, teaching context, affective or cognitive states of the learner, and other similar contexts in which the learning system will be implemented. Context log 508 may be stored in memory on user device 110, in memory on server 120, or in any other location.

With reference again to FIGS. 5 and 7, readiness score generator 510 is configured to generate a readiness score R for each student. At 702, once a topic is selected, readiness score generator 510 automatically generates a readiness score R for each student and for the class as a whole based on the data about student groups S received from student activity information 504 and student assessments 526 for the students. Readiness score generator 510 may identify a number K of prerequisite concepts C′ for a concept C and a number K′ of prerequisite concepts for each prerequisite concept C′, e.g., based on concept dependency graph 502. Readiness score generator 510 may use the data about student groups S to determine an engagement time for a student Si on the identified prerequisite concepts C′. The engagement time for student Si in prerequisite concepts C′ may include, for example, an amount of time spent in lectures on concepts C′, an amount of time spent engaged in learning activities for concepts C′, or other similar engagement times for students Si in any learning related to prerequisite concepts C′. For example, each event in the SAI 504 may include a time stamp. The time spent viewing a content or a page about a concept, the number of activities performed for the concept (e.g., for video content, the number of pauses, plays, fast forwards, etc.), a number of questions asked, or other similar activities.

Readiness score generator 510 may use the student assessments 526 for concept C and prerequisite concepts C′ to determine assessment scores for student Si in concept C and prerequisite concepts C′. Student assessments 526 may include, for example, quiz results, test results, assessments metadata (e.g., difficulty level, comprehension burden, etc.), or other similar assessments of a student Si's proficiency in concept C or in prerequisite concepts C′. In some aspects, student assessments 526 may be included in SAI 504. In some aspects, student assessments 526 may be generated any time prior to generation of the readiness score R by readiness score generator 510. For example, students may be assessed before, during, and/or after concept C or prerequisite concepts C′ are taught to the students. For example, the students may be given a pre-test in concept C prior to generating a learning system for teaching concept C to determine the students' initial proficiency in concept C. The students may also have been previously given a quiz or test at the time that prerequisite concepts C′ were taught to the students to determine a proficiency of the students in concepts C′ during and after the lessons on concepts C′ were taught to the students. Student assessments 526 may be stored in memory on user device 110, in memory on server 120, or in any other location.

In some aspects, the student assessments 526 may be a combination of any assessments taken by the students related to concept C and any prerequisite concepts C′. For example, a pre-test score for concept C may be combined with quiz and test scores for concepts C′ to determine student assessments 526. In some aspects, each pre-test, quiz, and test score may have an associated weighting. For example, final test scores on a concept C′ taken after a lesson on concept C′ was taught to the students may have a higher weighting than quiz scores from quizzes taken during the lesson on concept C′. As another example, a pre-test score for concept C may have higher weighting than quiz or test scores for concepts C′. Any other weighting of pre-test, test, and quiz assessment scores may be used. In some aspects, the weightings of the pre-test, test, and quiz assessment scores may be pre-determined by the system. In some aspects, the weightings of the pre-test, test, and quiz assessment scores may be set, for example, by system 100, by a user of system 100, and/or by a teacher that will be using the generated learning systems to teach students concepts.

In some aspects, readiness score generator 510 may also include a weight for engagement time, W_{E}, and a weight for assessment scores W_{A}. Weights W_{E} and W_{A} may determine what proportion of the readiness score R for each student Si is based on each of the engagement time and assessment scores, respectively. For example, if both engagement and assessment are weighted equally, W_{E} and W_{A} may both be 0.5, e.g., 50%. In some aspects, for example, if assessment scores are more valuable than engagement time in determining the readiness of a student, W_{A} may be larger than W_{E}, e.g., W_{A} may be 0.75, e.g., 75%, and W_{E} may be 0.25, e.g., 25%. In some aspects, for example, if engagement time is more valuable than assessment scores in determining the readiness of a student, W_{E} may be larger than W_{A}, e.g., W_{E} may be 0.75, e.g., 75%, and W_{A} may be 0.25, e.g., 25%. In some aspects, W_{E} and W_{A} together may equal 1.0, e.g., 100%. In some aspects W_{E} and W_{A} may equal less than 1.0. Weightings W_{E} and W_{A} may be set, for example, by the system, by a user of the system, and/or by the teacher that will be using the learning systems. Readiness score generator 510 may assess the determined engagement time and assessment scores for each prerequisite C′ according to the following equations:

R{C′}=(W_{E}*Engagement-time/Desired-Engagement-time+W_{A}*assessment-score/Desired-Proficiency)

R{C′}=min(1,R{C′})

Desired engagement time and desired proficiency may be set, for example, by system 100, by a user of system 100, and/or by the teacher that will be using the learning systems generated by system 100.

The readiness score R{C} for student Si for concept C may be the weighted average of the student Si's prerequisite readiness scores R{C′ }. Students S may be clustered together by system 100 into clusters of similar students 518 based on their individual readiness scores. In some aspects, for example, students having low readiness scores R, e.g., less than 0.5, may be grouped together in a first cluster, and students having high readiness scores R, e.g., greater than 0.5, may be grouped together in a second cluster. In some aspects, any other clustering may be used based on the individual student readiness scores R. For example, students in the bottom third of readiness scores R may be clustered together, students in the middle third of readiness scores R may be clustered together, and students in the top third of readiness scores may be grouped together.

In some aspects, the readiness score R of the entire class may be determined for a concept C. For example, the readiness score R of the entire class may be the average of the individual students' readiness scores R.

Referring again to FIGS. 5 and 7, at 704 teaching cost calculator 512 automatically determines a teaching cost T associated with teaching a concept C to the students in a class based on inputs received from concept dependency graph 502, lesson and activity logs 506, and readiness score generator 510. For example, the teaching cost T of teaching a concept C3 (FIG. 6) requires students to understand the prerequisite concepts C1 and C2 (FIG. 6). The total teaching cost T may be determined based on the cost of teaching activities related to concept C3 as well as the cost of teaching activities related to prerequisite concepts C1 and C2, where, for example, the students proficiencies in concepts C1 and C2 are not sufficient to teach concept C3 right away. For example, the total teaching cost T may be the sum of the teaching cost T_{c} of teaching concept C1 and the cost Tₚᵣₑ(c) of teaching prerequisite concepts C2 and C3. The cost T_{c} of teaching a concept C is the cost of all activities associated with teaching the concept C where pre(c) contains the set of J prerequisite concepts for concept C, for example, pre(c)={C₁, C₂, C₃ . . . Cⱼ}. The cost Tpre(c) is the cost of teaching all the pre-requisites concept of concept C:

$$Tpre ( c ) = {\sum }_{j = 1}^{J} ( 1 - R ) {W}_{j} {T}_{j} )$$

Tⱼ is the cost of teaching the prerequisite concept Cj.

Wⱼ is the weight that prerequisite j contributes to the overall teaching cost T. The weight Wj is arrived at by the weight 604 of the edges in concept dependency graph 600. A weight Wj for a prerequisite concept may, for example, be a percentage, e.g., 0% to 100%, a decimal, e.g., 0.0 to 1.0, an integer, e.g., 0 to 10, or other similar values that indicate a relative weight of each prerequisite concept C′.

The total teaching cost T of concept C may be determined based on the cost to attain a desired proficiency P in the prerequisites of concept C, based on the contribution of dependency factors between concept C and prerequisites C′ to be taught to attain the desired proficiency P, and based on the accrual debt D between concept C and prerequisite concepts C′ when the required readiness score R is not attained. The desired proficiency P may be provided as an input into learning system generator 516. For example, the desired proficiency P may be set by a user of system architecture 500.

If the readiness cost determined by readiness score generator 510 for the student group has a high readiness cost R, the cost Tₚᵣₑ(c) will be low. If the weight W₃ of a prerequisite concept C′ is low, the cost of teaching that prerequisite concept C′ will also be low. For example, a low weight Wj for a prerequisite concept C′ may be a weight Wj that is close to 0%, e.g., 5%, 25%, or other similar low weights. For example, as the weight approaches 0%, the relative value of the prerequisite concept C′ to a readiness score for the concept C is reduced.

Still referring to FIGS. 5 and 7, at 706 learning system generator 516 may generate optimal learning systems 520 based on numerous factors including, for example, the total teaching cost T received from teaching cost calculator 512, inputs received from lesson and activity logs 506 (e.g., engagement time and assessment scores), desired proficiency DP, maximum debt allowed Dₘₐₓ, and maximum cost allowed Tₘₐₓ received from context log 508, hours available for teaching t received from the teacher calendar 514, and accrual debt D received from teaching debt calculator 524.

Learning system generator 516 may automatically determine whether T_{c}, the teaching cost for a concept C, is less than t, the total hours available for the teacher. If T_{c} is less than t, learning system generator 516 may recommend an increase in t for teaching a lesson for concept C, for example, via either of user interfaces 300 and 400. For example, learning system generator 516 may increase the available amount of time t up to a maximum available time Tₘₐₓ for the teacher. In some aspects, an increase in the available time t for concept C may require a reduction in the available time t allocated to other concepts. For example, if the available time t for concept C is increased above the maximum available time Tₘₐₓ, the available time t for another concept, or even for a prerequisite concept C′, may be reduced by at least a portion of the increase.

Learning system generator 516 may automatically identify learning materials to be used with teaching a lesson for concept C that is aligned with a preference model of {S}, R, D, and T. For example, learning system generator 516 may determine or select learning resources, e.g., books, lecture materials, slideshows, etc., from lesson and activity logs 506 that are configured for use by a class or group of students S having a readiness score R and that meet the teaching cost T. Learning system generator 516 may also determine or select learning activities, e.g., interactive lessons, games, or other activities, from lesson and activity logs 506 that are configured for use by a class or group of students S having a readiness score R and that meet the teaching cost T.

For example, learning system generator 516 may determine the recommended learning materials and/or activities for use in teaching concept C and prerequisite concepts C′ based on the individual students and class readiness scores R and may estimate a time (e.g., teaching cost T(c)) required for learning the materials/activities selected.

Learning system generator 516 may determine a recommended learning system for the combination of concepts C and C′, for example, based on the weights of each prerequisite from concept dependency graph 502, given a maximum amount of available teaching time t (available hours), a maximum teaching cost Tₘₐₓ, maximum accrual debt Dₘₐₓ, and a desired proficiency level DP in concept C that preserves the partial ordering of concept dependency within the available hours t while maintaining the accrual debt D below the maximum debt Dₘₐₓ. In some aspects, learning system generator 516 may use Dₘₐₓ and Tₘₐₓ as constraints to generate multiple learning systems using planning and scheduling algorithms.

At 708, learning system generator 516 may publish the optima_{l l}earnin_{g s}ystems 520 as recommendations to the te_{ach}er, for example, via use_{r i}nterfaces 300 and 400. The teacher may review the published optimal learning systems 520 and may create modified learning systems 522. The modified learning systems may be used to teach the students concept C.

In some aspects, the optimal learning systems 520 generated by learning system generator 516 may also determine optimized clusters of similar students 518 for learning each learning system. For example, each learning system may include a readiness score value, e.g., readiness score 420 from FIG. 4, that may be used to determine student clusters. For example, students that meet the readiness score for a learning system may be clustered together to learn based on that learning system. Similarly, when a group of students does not meet the readiness score for a particular learning system that group of students may also be clustered together and a new learning system may be recommended for that group that matches their readiness score. In some aspects, clusters of students may be determined based on their readiness scores where, for example, students with similar readiness scores may form a cluster.

Once the learning systems have been recommended, modified, and selected for use by the teacher, the students in the clusters may be taught the learning system and their proficiency may be assessed using student assessments 526 at 712. At 714, the modified learning systems and student assessments 526 may be provided to teaching debt calculator 524 and teaching debt calculator 524 may determine an accrued debt D based on the teacher modified learning systems and the student assessments 526. The accrued debt D may be equivalent to the teaching cost for any portions of the recommended lesson that the teacher fails to teach to the students. For example, if the learning system that the teacher selects requires a readiness score of 75% but the class or one or more of the student clusters has a readiness score of 50%, the accrual debt D may be equal to the teaching cost that it would take to increase the readiness score of the students to 75%. For example, the accrual debt D may be equivalent to the teaching cost of any prerequisites concepts C′ or activities that the teacher decided not to teach. For example, where R is the required readiness score of a prerequisite concept, R′ is the current readiness score of the prerequisite concept, and T is the cost of each prerequisite concept, the accrual debt D may be determined according to the following formula:

D=(R−R′)ΣT

The student assessments 526 and accrual debt D may then be used as inputs to readiness score generator 510 and learning system generator 512 for determining readiness scores R and generating new learning systems for future teaching concepts C. For example, the debt D may be the set of concepts that have not been covered that should now be covered as part of lesson plan to reach a desired readiness score. In this manner, system 100 may automatically and dynamically generate new learning systems for a group of students based on the performance, proficiencies, readiness score, prior learning history and engagement time in prerequisite concepts, teaching costs, accrual debt, and other information about the group of students that is relevant to the generation of learning systems.

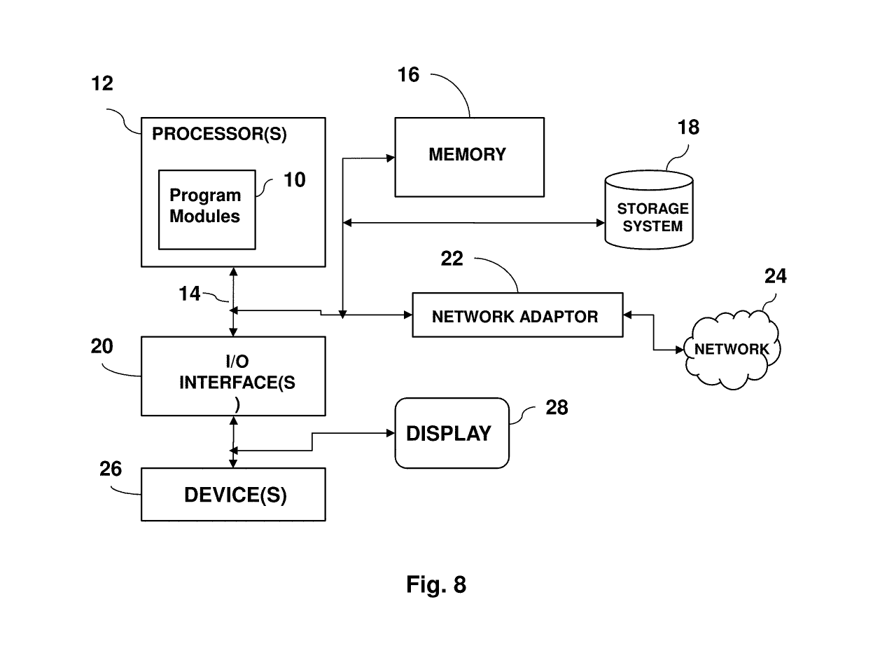

FIG. 8 illustrates a schematic of an example computer or processing system that may implement any or all of learning system optimization system 100, user device 110, server 120, and in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the system shown in FIG. 1 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of the computer system may include, but are not limited to, one or more processors or processing units 12, a system memory 16, and a bus 14 that couples various system components including system memory 16 to processor 12. The processor 12 may include one or more program modules 10 that perform the methods described herein. The program modules 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method performed by at least one hardware processor, comprising:
presenting a user interface on a display of a computing device, the user interface configured to present learning systems to a user, the user interface including at least one element that is activatable by a user to select a concept to be used in generating a learning system for teaching the concept to one or more students;
receiving from the user via the user interface an activation of the at least one element, the activation indicating a selected concept;
in response to receiving the activation indicating the selected concept:
identifying at least one prerequisite concept to the selected concept;
determining a readiness score of a group of students for learning the at least one identified prerequisite concept, the readiness score based at least on a proficiency of the group of students in the at least one identified prerequisite concept;
determining a readiness score of the group of students for learning the selected concept based at least in part on the determined readiness score of the group of the students for learning the at least one identified prerequisite concept;
determining a total teaching cost for teaching the group of students the selected concept, the total teaching cost based at least in part on:
a teaching cost associated with teaching the selected concept to the group of students;
a teaching cost associated with teaching the at least one prerequisite concept to the group of students; and
the determined readiness scores of the group of students for learning the selected concept and the at least one prerequisite concept;
generating a learning system for teaching the selected concept based at least in part on the determined total teaching cost; and
presenting the learning system to the user via the user interface.

2. The method of claim 1, further comprising:
retrieving, from memory of a computing device, student assessments for the at least one prerequisite concept, wherein the proficiency of the group of students in the at least one prerequisite concept is based on the retrieved student assessments for the at least one prerequisite concept.

3. The method of claim 1, further comprising:
retrieving, from memory of a computing device, an amount of engagement time that the group of students have spent learning the at least one prerequisite concept, wherein the readiness score for the at least one prerequisite concept is based at least on the retrieved amount of engagement time.

4. The method of claim 1, further comprising:
retrieving, from memory of a computing device, a concept dependency graph identifying the prerequisite concepts for the selected concept and a relative weight for each prerequisite concept to the selected concept, wherein the at least one prerequisite concept to the selected concept is identified based on the retrieved concept dependency graph.

5. The method of claim 1, further comprising
receiving a modified learning system from the user via the user interface, the modified learning system including less than all of the prerequisite concepts included in the learning system;
receiving student assessments based on the modified learning system; and
updating an accrual debt amount based on the modified learning system and the student assessments.

6. The method of claim 5, wherein the accrual debt amount is updated based on the teaching cost of any prerequisite concept that is not included in the modified teaching plan but is included in the recommended teaching plan.

7. The method of claim 1, further comprising:
comparing the determined total teaching cost to an amount of time available for teaching learning systems;
determining based on the comparison that the amount of time available for teaching learning systems is less than the total teaching cost; and
providing a recommendation via the user interface to increase the total amount of time available for teaching learning systems.

8. A system comprising:
at least one processor comprising hardware, the at least one processor configured to:
present a user interface on a display of a computing device, the user interface configured to present learning systems to a user, the user interface including at least one element that is activatable by a user to select a concept to be used in generating a learning system for teaching the concept to one or more students;
receive from the user via the user interface an activation of the at least one element, the activation indicating a selected concept;
in response to receiving the activation indicating the selected concept:
identify at least one prerequisite concept to the selected concept;
determine a readiness score of a group of students for learning the at least one identified prerequisite concept, the readiness score based at least on a proficiency of the group of students in the at least one identified prerequisite concept;
determine a readiness score of the group of students for learning the selected concept based at least in part on the determined readiness score of the group of the students for learning the at least one identified prerequisite concept;
determine a total teaching cost for teaching the group of students the selected concept, the total teaching cost based at least in part on:
a teaching cost associated with teaching the selected concept to the group of students;
a teaching cost associated with teaching the at least one prerequisite concept to the group of students; and
the determined readiness scores of the group of students for learning the selected concept and the at least one prerequisite concept;
generate a learning system for teaching the selected concept based at least in part on the determined total teaching cost; and
present the learning system to the user via the user interface.

9. The system of claim 8, wherein the at least one processor is further configured to:
retrieve, from memory of a computing device, student assessments for the at least one prerequisite concept, wherein the proficiency of the group of students in the at least one prerequisite concept is based on the retrieved student assessments for the at least one prerequisite concept.

10. The system of claim 8, wherein the at least one processor is further configured to:
retrieve, from memory of a computing device, an amount of engagement time that the group of students have spent learning the at least one prerequisite concept, wherein the readiness score for the at least one prerequisite concept is based at least on the retrieved amount of engagement time.

11. The system of claim 8, wherein the at least one processor is further configured to:
retrieve, from memory of a computing device, a concept dependency graph identifying the prerequisite concepts for the selected concept and a relative weight for each prerequisite concept to the selected concept, wherein the at least one prerequisite concept to the selected concept is identified based on the retrieved concept dependency graph.

12. The system of claim 8, wherein the at least one processor is further configured to:
receive a modified learning system from the user via the user interface, the modified learning system including less than all of the prerequisite concepts included in the recommended learning system;
receive student assessments based on the modified learning system; and
update an accrual debt amount based on the modified learning system and the student assessments.

13. The system of claim 12, wherein the accrual debt amount is updated based on the teaching cost of any prerequisite concept that is not included in the modified teaching plan but is included in the recommended teaching plan.

14. The system of claim 8, wherein the at least one processor is further configured to:
compare the determined total teaching cost to an amount of time available for teaching learning systems;
determine based on the comparison that the amount of time available for teaching learning systems is less than the total teaching cost; and
provide a recommendation via the user interface to increase the total amount of time available for teaching learning systems.

15. A non-transitory computer readable medium storing instructions that, when executed by at least one processor, configure the at least one processor to:
present a user interface on a display of a computing device, the user interface configured to present learning systems to a user, the user interface including at least one element that is activatable by a user to select a concept to be used in generating a learning system for teaching the concept to one or more students;
receive from the user via the user interface an activation of the at least one element, the activation indicating a selected concept;
in response to receiving activation indicating the selected concept:
identify at least one prerequisite concept to the selected concept;
determine a readiness score of a group of students for learning the at least one identified prerequisite concept, the readiness score based at least on a proficiency of the group of students in the at least one identified prerequisite concept;
determine a readiness score of the group of students for learning the selected concept based at least in part on the determined readiness score of the group of the students for learning the at least one identified prerequisite concept;
determine a total teaching cost for teaching the group of students the selected concept, the total teaching cost based at least in part on:
a teaching cost associated with teaching the selected concept to the group of students;
a teaching cost associated with teaching the at least one prerequisite concept to the group of students; and
the determined readiness scores of the group of students for learning the selected concept and the at least one prerequisite concept;
generate a learning system for teaching the selected concept based at least in part on the determined total teaching cost; and
present the learning system to the user via the user interface.

16. The non-transitory computer readable medium of claim 15, wherein the instructions further configure the at least one processor to:
retrieve, from memory of a computing device, student assessments for the at least one prerequisite concept, wherein the proficiency of the group of students in the at least one prerequisite concept is based on the retrieved student assessments for the at least one prerequisite concept.

17. The non-transitory computer readable medium of claim 15, wherein the instructions further configure the at least one processor to:
retrieve, from memory of a computing device, an amount of engagement time that the group of students have spent learning the at least one prerequisite concept, wherein the readiness score for the at least one prerequisite concept is based at least on the retrieved amount of engagement time.

18. The non-transitory computer readable medium of claim 15, wherein the instructions further configure the at least one processor to:
retrieve, from memory of a computing device, a concept dependency graph identifying the prerequisite concepts for the selected concept and a relative weight for each prerequisite concept to the selected concept, wherein the at least one prerequisite concept to the selected concept is identified based on the retrieved concept dependency graph.

19. The non-transitory computer readable medium of claim 15, wherein the instructions further configure the at least one processor to:
receive a modified learning system from the user via the user interface, the modified learning system including less than all of the prerequisite concepts included in the recommended learning system;
receive student assessments based on the modified learning system; and
update an accrual debt amount based on the modified learning system and the student assessments.

20. The system of claim 19, wherein the accrual debt amount is updated based on the teaching cost of any prerequisite concept that is not included in the modified teaching plan but is included in the recommended teaching plan.
